(19) United States
(12) Patent Application Publication
(10) Pub. No.: US 2025/0219951 A1
(43) Pub. Date: Jul. 3, 2025

(54) FLOW MANAGEMENT BASED ON STREAM CLASSIFICATION SERVICE NEGOTIATIONS AND POLICIES

(71) Applicant: Cisco Technology, Inc., San Jose, CA (US)

(72) Inventors: Binita Gupta, SAN DIEGO, CA (US); Brian Hart, Sunnyvale, CA (US); Malcolm Smith, Richardson, CA (US); Jerome Henry, Pittsboro, NC (US)

(21) Appl. No.: 18/656,475

(22) Filed: May 6, 2024

Related U.S. Application Data
(60) Provisional application No. 63/615,727, filed on Dec. 28, 2023.

(51) Int. Cl. H04L 47/2408; H04L 47/12; H04L 47/62

(52) U.S. Cl. CPC H04L 47/2408; H04L 47/12; H04L 47/6215

(57) ABSTRACT

In embodiments described herein, one or more stream classifications are incorporated into a plurality of flows within a network. These flows can have a number of characteristics associated with it, such as, but not limited to quality of service requirements that can dictate how the flow should be processed. A device associated with the flow can transmit a stream classification service (SCS) request. This SCS request can be received and processed to determine a scheduling behavior that should be adopted by various network device/nodes associated with the flow. The scheduling behavior can be transmitted to those network devices which can then modify the processing of the flow(s). In some cases, the network device can classify the packets associated with the flow(s) and prioritize them. In additional cases, the network device can generate one or more new queues that can be configured to best serve the requirements of the flow.

### CROSS-REFERENCE TO RELATED APPLICATION

This application claims the benefit of U.S. Provisional Patent Application No. 63/615,727, filed Dec. 28, 2023, which is incorporated by reference herein in its entirety.

The present disclosure relates to wireless networking. More particularly, the present disclosure relates to managing flows based on stream classification negotiations.

### BACKGROUND

Wi-Fi, or wireless fidelity, is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

### SUMMARY OF THE DISCLOSURE

Systems and methods for managing flows based on stream classification negotiations in accordance with embodiments of the disclosure are described herein. In some embodiments, a device includes a processor, at least one network interface controller configured to provide access to a network, and a memory communicatively coupled to the processor, wherein the memory includes a flow management logic. The logic is configured to receive a stream classification service (SCS) request, select a flow based on the SCS request, identify a flow policy, determine a scheduling behavior related to the flow policy, and transmit the scheduling behavior to one or more network devices.

In some embodiments, the SCS request is received from a client device.

In some embodiments, determining a scheduling behavior is based on quality of service characteristics of the flow.

In some embodiments, the quality of service is associated with at least one application.

In some embodiments, the flow management logic is further configured to generate a classification based on at least the flow policy.

In some embodiments, the classification is associated with an internet protocol header.

In some embodiments, the classification is a differentiated services code point marking.

In some embodiments, the marking is applied to an upstream flow.

In some embodiments, the flow management logic is further configured to generate one or more queues in response to the scheduling behavior.

In some embodiments, the one or more queues are generated in response to one or more quality of service characteristics of the flow.

In some embodiments, a device includes a processor, at least one network interface controller configured to provide access to a network, and a memory communicatively coupled to the processor, wherein the memory includes a flow management logic. The logic is configured to determine a flow for classification, classify the flow, receive a scheduling behavior for the flow, and schedule the flow based on the scheduling behavior.

In some embodiments, the flow management logic is further configured to analyze the scheduling behavior.

In some embodiments, the flow management logic is further configured to prioritize the scheduling of the flow based on the scheduling behavior analysis.

In some embodiments, a method of managing flows, includes establishing a connection to a network, receiving a stream classification service (SCS) request from a network device on the network, selecting a flow based on the SCS request, identifying a flow policy based on the SCS request, determining a scheduling behavior based on the flow policy, and transmitting the scheduling behavior to the network device.

In some embodiments, the method further includes forwarding the scheduling behavior to additional network devices on a network.

In some embodiments, the additional network devices are not connected via a wireless connection.

In some embodiments, the additional network devices are routing nodes.

In some embodiments, the method further includes generating one or more classifications based on the scheduling behavior.

In some embodiments, the method further includes generating one or more additional queues in response to the scheduling behavior.

In some embodiments, the one or more additional queues are generated based on at least a quality of service characteristic associated with the SCS request.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic block diagram of a call flow in a power management system, in accordance with various embodiments of the disclosure;

FIG. 3 is a conceptual network diagram of various environments that a flow management logic may operate on a plurality of network devices, in accordance with various embodiments of the disclosure;

FIG. 4 is a conceptual illustration of a stream classification service queuing/forwarding system, in accordance with various embodiments of the disclosure; and

FIG. 5 is a conceptual illustration of network queueing/forwarding policy modifications being set by an access point, in accordance with various embodiments of the disclosure.

FIG. 6 is a flowchart depicting a process for configuring network devices based on flow policies in accordance with various embodiments of the disclosure;

FIG. 7 is a flowchart depicting a process for modifying a flow classification in accordance with various embodiments of the disclosure;

FIG. 8 is a flowchart depicting a process for receiving a modified flow classification in accordance with various embodiments of the disclosure;

FIG. 9 is a flowchart depicting a process for processing flows in accordance with various embodiments of the disclosure; and

FIG. 10 is a conceptual block diagram of a device suitable for configuration with a flow management logic and a flow management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

Differentiated Services/Differentiated Services Code Point (Diffserv/DSCP) markings within Internet Protocol (IP) headers are typically utilized at routing nodes to ascertain the per-hop queuing and forwarding behavior for IP packets. For instance, packets marked with DSCP 46 are assigned Expedited Forwarding (EF) per-hop behavior, resulting in prioritized queuing of such packets at network nodes. Nonetheless, there may exist multiple application flows marked with the same DSCP designation (e.g., DSCP 46 is employed by both video conferencing and Augmented Reality/Virtual Reality (AR/VR) flows). Each of these application flows can possess distinct traffic characteristics, such as varying data rates and latency requirements (e.g., 100 milliseconds latency for video conferencing versus 10 milliseconds latency for AR/VR, etc.), as outlined in the Service Characteristic Set (SCS) request transmitted from the client device to the Access Point (AP). For such SCS flows, a mechanism is imperative to differentiate and enhance the Quality of Service (QOS) for these unique flows, taking into account the specific traffic requirements of each flow delineated in the SCS QoS Characteristics element, alongside the DSCP markings.

In response to the issues described above, devices and methods are discussed herein that can modify flows in a more granular way in order to improve quality of service levels of various streams within the flows. In wireless networking, a stream classification service plays a role in managing and optimizing the flow of data across the network. It serves as an intelligent mechanism for categorizing and prioritizing different types of data streams or traffic based on various attributes, ensuring efficient utilization of network resources, and meeting specific quality of service (QOS) requirements. At its core, a stream classification service operates by inspecting incoming data packets and applying predefined rules or policies to classify them into different classes or categories. These rules can be based on a variety of factors, including the network protocol being used, the application generating the traffic, quality of service requirements, source or destination addresses, and more.

For example, traffic generated by real-time applications such as VoIP or video conferencing may be classified as high-priority due to its sensitivity to latency and packet loss. On the other hand, bulk data transfers or background applications may be classified as low-priority since they are less time-sensitive and can tolerate delays. Once traffic is classified, network devices such as routers, switches, or access points can apply different treatment policies to each class of traffic. This could include prioritizing high-priority traffic for faster forwarding, allocating more bandwidth to critical applications, or implementing traffic shaping and congestion control mechanisms to prevent network congestion and ensure fair resource allocation. By implementing a stream classification service, wireless networks can effectively manage the diverse array of traffic types and applications traversing the network. This not only helps optimize network performance and utilization but also ensures that critical applications receive the necessary resources and meet the required QoS standards, ultimately enhancing the overall user experience and productivity in wireless networking environments.

IP headers play a fundamental role in facilitating communication between devices over the Internet Protocol (IP). An IP header is a component of the IP packet, which contains desired information required for routing and delivering data packets across networks. It serves as the envelope that encapsulates the payload of the packet, ensuring that it reaches its intended destination accurately and efficiently. The IP header typically consists of several fields, each serving a specific purpose in the packet delivery process. One of the most critical fields is the source and destination IP addresses, which specify the source and destination devices participating in the communication. These addresses are desired for routing the packet through intermediate network devices and ultimately reaching the intended recipient.

Another desired field in the IP header is the Type of Service (ToS) or Differentiated Services Code Point (DSCP), which allows packets to be classified and prioritized based on their QoS requirements. By assigning a specific value to this field, network administrators can ensure that certain types of traffic, such as real-time voice or video data, receive preferential treatment in terms of bandwidth allocation and forwarding priority. Additionally, the IP header contains fields for identifying the protocol used in the payload of the packet, such as TCP (Transmission Control Protocol), UDP (User Datagram Protocol), or ICMP (Internet Control Message Protocol). This information is for the receiving device to understand how to interpret and process the data contained in the packet.

Furthermore, the IP header includes fields for packet fragmentation and reassembly, allowing large packets to be divided into smaller fragments for transmission across networks with varying maximum transmission unit (MTU) sizes. These fields help ensure that data packets can traverse networks with different link layer technologies and network configurations without being lost or corrupted. DSCP (Differentiated Services Code Point) markings are used as a method for classifying and prioritizing IP packets based on their quality of service (QOS) requirements. DSCP markings are embedded in the IP header of each packet and are utilized by routers, switches, and other network devices to make forwarding and queuing decisions.

The DSCP field in the IP header allows packets to be classified into different classes or traffic categories, each with its own priority level. This classification enables network administrators to prioritize certain types of traffic over others, ensuring that critical applications receive the necessary resources and network performance, particularly in wireless networks where bandwidth and resources may be limited or variable. DSCP markings are typically represented by a 6-bit value, allowing for up to 64 different code points. These code points are organized into different service classes, such as Expedited Forwarding (EF), Assured Forwarding (AF), and Best Effort (BE), each with its own set of priority levels and treatment policies.

Expedited Forwarding (EF) is typically assigned the highest priority and is used for real-time applications that require low latency and minimal packet loss, such as voice or video conferencing. Packets marked with EF DSCP values are often given preferential treatment in terms of forwarding and queuing, ensuring timely delivery and minimal delay. Assured Forwarding (AF) provides a more granular approach to traffic prioritization, allowing packets to be classified into multiple priority levels within each AF class. This enables network administrators to differentiate between different types of traffic and allocate resources accordingly, based on their relative importance and QoS requirements. Best Effort (BE) is the default service class for packets that do not have a specific DSCP marking assigned. Packets in this class are typically treated with lower priority and may experience higher latency and packet loss compared to packets with higher-priority DSCP markings.

In contrast to DSCP (Differentiated Services Code Point) markings, “Diffserv” stands for Differentiated Services. Diffserv is a mechanism used in computer networking to provide quality of service (QOS) differentiation and traffic management in IP networks. It is based on the concept of classifying and prioritizing packets according to their DSCP markings, allowing network administrators to apply different treatment policies to various types of traffic. Diffserv operates by dividing traffic into different service classes or traffic categories, each with its own set of forwarding and queuing behaviors. These service classes are defined based on the DSCP markings embedded in the IP header of each packet. By assigning specific DSCP values to different types of traffic, network administrators can differentiate between critical, real-time applications requiring low latency and minimal packet loss, and less time-sensitive, best-effort traffic.

Diffserv enables routers, switches, and other network devices to make forwarding and queuing decisions based on the DSCP markings of incoming packets. For example, packets with higher-priority DSCP markings, such as Expedited Forwarding (EF) or Assured Forwarding (AF), may be given preferential treatment in terms of bandwidth allocation, queuing priority, and forwarding decisions, ensuring that critical applications receive the necessary resources and network performance. Diffserv provides a flexible and scalable approach to QoS management, allowing network administrators to define and enforce traffic policies based on the specific requirements of their network and applications. By leveraging Diffserv and DSCP markings, wireless networks can prioritize critical traffic, minimize latency, and optimize resource utilization, thereby enhancing the overall user experience and network performance.

Routing nodes play a pivotal role in wireless networking by facilitating the transmission of data packets between devices within the network and enabling communication with devices outside the network. These nodes act as intermediaries that receive, analyze, and forward data packets based on routing algorithms and network topology information. In wireless networking, routing nodes can take various forms, including wireless routers, access points, switches, and even individual devices equipped with routing functionality. These nodes collaborate to form a network infrastructure that enables devices to communicate with each other, regardless of their physical location within the coverage area.

One of the primary functions of routing nodes is to determine the optimal path for data packets to reach their destination based on routing protocols and network conditions. This involves evaluating factors such as packet destination, network congestion, link quality, and available bandwidth to select the most efficient route for packet transmission. Routing nodes also participate in routing table management, where they maintain and update routing tables that contain information about network topology, neighboring nodes, and available routes. By exchanging routing updates with neighboring nodes, routing nodes can adapt to changes in the network, such as link failures or topology changes, and dynamically reroute traffic to ensure continuous connectivity and efficient packet delivery. In addition to forwarding data packets, routing nodes may also perform other functions such as packet filtering, network address translation (NAT), quality of service (QOS) management, and security enforcement. These additional functionalities help optimize network performance, enhance security, and ensure that network resources are utilized effectively.

Per-hop queuing and forwarding behavior in wireless networking refer to the process by which individual network nodes, such as routers or access points, manage the transmission of data packets as they traverse the network. This process involves queuing incoming packets, making forwarding decisions, and determining the order in which packets are transmitted out of the node's interfaces. At each hop or network node, packets are typically placed into different queues based on their priority, traffic class, or other criteria defined by the network's quality of service (QOS) policies. This queuing process allows the node to prioritize certain packets over others, ensuring that critical traffic, such as real-time applications or voice calls, receives preferential treatment in terms of bandwidth allocation and transmission delay.

Per-hop queuing mechanisms can vary depending on the specific QoS policies implemented by the network. Common queuing techniques include First-In-First-Out (FIFO), where packets are transmitted in the order they were received, and priority queuing, where higher-priority packets are dequeued and transmitted ahead of lower-priority packets. Other advanced queuing schemes, such as Weighted Fair Queuing (WFQ) or Deficit Round Robin (DRR), provide more granular control over packet scheduling and bandwidth allocation, allowing network administrators to prioritize traffic based on its importance and requirements. Switches and routers also employ active queue management (AQM) to drop certain packets before queuing buffers become full to avoid congestion and achieve improve end-to-end latency.

In addition to queuing, per-hop forwarding behavior involves making decisions about how to route packets to their next destination. This decision-making process is typically based on routing protocols, such as RIP (Routing Information Protocol), OSPF (Open Shortest Path First), or BGP (Border Gateway Protocol), which exchange routing information between network nodes and calculate the best path for packet transmission. Forwarding decisions may also take into account factors such as network congestion, link quality, and policy-based routing rules. For example, if a wireless node has multiple outgoing interfaces or paths to reach a destination, it may use load balancing techniques to distribute traffic across these paths evenly or select the path with the least latency or congestion.

Quality of Service (QOS) in wireless networking refers to the set of techniques and mechanisms used to manage and prioritize the transmission of data packets over a wireless network in order to meet specific performance requirements and ensure a satisfactory user experience. In wireless networks, where bandwidth is often limited and the quality of the wireless link may vary due to factors such as interference, signal attenuation, and congestion, QoS mechanisms are for optimizing network performance and delivering consistent service to users. QoS in wireless networking encompasses various aspects, including prioritization of traffic, bandwidth allocation, latency management, and packet loss prevention. One of the primary goals of QoS is to ensure that critical applications, such as voice and video communication or real-time data streaming, receive preferential treatment over less time-sensitive traffic, such as web browsing or file downloads. This is achieved through techniques like packet classification and marking, where data packets are assigned specific priority levels or differentiated service code points (DSCP) based on their application requirements or QOS policies.

Bandwidth allocation is another key aspect of QoS in wireless networking, as it involves determining how network resources are distributed among different types of traffic to ensure fair and efficient utilization. QoS mechanisms such as traffic shaping, traffic policing, and admission control help regulate the flow of traffic and prevent congestion by limiting the rate at which data is transmitted or by selectively dropping or delaying packets when necessary. Latency management is critical for applications that are sensitive to delays, such as voice over IP (VOIP) or online gaming, where even small delays can degrade the user experience. QoS mechanisms such as priority queuing, low-latency queuing, and traffic prioritization techniques help minimize latency by ensuring that time-sensitive traffic is given priority treatment and transmitted without unnecessary delays.

Packet loss prevention is another important aspect of QoS in wireless networking, as it helps maintain data integrity and reliability, especially in environments prone to interference or signal degradation. QoS mechanisms such as forward error correction (FEC), retransmission, and packet reordering help mitigate packet loss and ensure that data is delivered accurately and in the correct sequence. Different applications often have varying quality of service (QOS) requirements due to differences in their sensitivity to factors such as latency, bandwidth, jitter, and packet loss. Understanding these differences is for effectively managing network resources and ensuring that each application receives the necessary QoS to operate optimally.

Real-time applications, such as voice over IP (VOIP), video conferencing, and online gaming, typically have stringent QoS requirements due to their sensitivity to latency and packet loss. For example, in VOIP applications, even small delays in packet transmission can result in noticeable degradation in call quality or conversational delays. Therefore, VOIP traffic requires low latency and minimal packet loss to ensure clear and uninterrupted communication. Similarly, video conferencing applications require a consistent and reliable network connection to maintain high-quality video streams without interruptions or buffering. High-definition video streams can consume bandwidth, so ensuring sufficient bandwidth allocation and low latency is desired to prevent degradation in video quality or stuttering during playback.

On the other hand, bulk data transfer applications, such as file downloads, software updates, or backups, are less sensitive to latency and packet loss compared to real-time applications. While these applications may benefit from higher bandwidth and faster transmission speeds, they can tolerate occasional delays or packet loss without impact on user experience. Interactive web applications, such as web browsing, email, and instant messaging, have moderate QoS requirements and typically prioritize responsiveness and user interactivity over strict latency or packet loss constraints. While these applications may benefit from low latency and minimal jitter, they are generally more tolerant of occasional delays or packet loss, as long as the overall user experience remains acceptable. Furthermore, critical infrastructure applications, such as remote monitoring, control systems, and financial transactions, often require high reliability and security in addition to low latency and minimal packet loss. These applications may employ dedicated network connections, quality of service guarantees, and encryption to ensure data integrity, confidentiality, and availability.

In the context of wireless networking and SCS (Stream Classification Service) flows, “TCLAS” refers to Traffic Classification, while “FQDN” stands for Fully Qualified Domain Name. These terms are desired components in the process of classifying and managing data traffic within wireless networks, particularly in scenarios where granular control over traffic prioritization and management is required. Traffic Classification (TCLAS) involves the identification and categorization of data packets based on specific attributes or criteria, such as protocol type, application type, source or destination IP addresses, and port numbers. TCLAS enables network administrators to differentiate between different types of traffic and apply appropriate QoS policies or treatment mechanisms to each category.

For example, VoIP traffic may be classified differently from web browsing or file transfer traffic, as VoIP requires low latency and minimal packet loss for optimal performance. By using TCLAS, network administrators can assign specific priority levels or DSCP (Differentiated Services Code Point) markings to each traffic class, ensuring that critical applications receive the necessary resources and QoS treatment. Fully Qualified Domain Name (FQDN) refers to the complete domain name of a specific network device or service, including its hostname and domain suffix. In wireless networking, FQDNs are often used to identify endpoints, servers, or services accessed by devices within the network. By resolving FQDNs to their corresponding IP addresses using Domain Name System (DNS) resolution, network devices can establish connections to remote hosts or services. In the context of SCS flows, FQDNs may be used as part of the traffic classification process to identify and categorize traffic based on its destination. For example, traffic destined for specific FQDNs associated with critical services or applications may be given higher priority or subjected to specific QoS policies to ensure optimal performance.

The relationship between streams and flows can help to effectively manage data traffic, especially in the context of Quality of Service (QOS) control. Streams represent continuous sequences of data packets associated with specific communication sessions or applications, each possessing unique traffic patterns and QoS demands. These streams could include various types of data, such as audio or video streams, real-time communication sessions, or file transfers. Stream classification involves categorizing these data streams based on parameters like their source, destination, protocol, and specific QoS requirements. On the other hand, flows are aggregates of data packets that share common characteristics and are treated as a single entity within the network. Flows may encompass multiple streams or packets belonging to the same communication session or exhibiting similar attributes. They are typically defined based on factors like IP addresses, ports, protocol types, and other header fields. Flow classification involves grouping packets or streams into flows to apply consistent QoS policies and management practices. While a single stream might correspond to a single flow in simpler network environments, in more complex scenarios, multiple streams could be aggregated into a single flow for better resource allocation and management efficiency. Overall, understanding the relationship between streams and flows is desired for network administrators to efficiently categorize, prioritize, and manage data traffic to meet the diverse QoS needs of various applications and services.

In many embodiments, to provide a mechanism to differentiate and boost the overall end-to-end QoS for SCS flows the specific flow traffic requirements received in the SCS QoS Characteristics element are considered, in addition to the DSCP markings. Embodiments described herein present a method for an AP to receive an SCS request from a device, and apply an override for the flow characteristics, based on the flow classification for the enterprise. The AP may then proceed to enable flow scheduling based on this classification. The AP can then inform the device of the decision, causing (in some cases) the device to reconsider the intended flow structure.

The Diffserv/DSCP markings in the IP header are typically used at routing nodes to determine the per-hop queuing and forwarding behavior for IP packets. For example, DSCP 46 marked packets are given EF (Expedited Forwarding) per-hop behavior leading to queuing prioritization of such packets at the network nodes. However, there can be multiple app flows which are marked with the same DSCP marking (e.g. DSCP 46 is used by both Webex and AR/VR flow), but they have different traffic characteristics such as different data rate and latency requirement (e.g. 100 millisecond latency for virtual conferencing versus 10 millisecond latency for AR/VR) as indicated in the SCS request sent by the device to the AP.

RFC 4594, and other QoS-focused RFCs of the same generation, focus on defining traffic classes (e.g. telephony) and suggesting a label for these classes, and a target per hop treatment (this second part is only generally defined, as the precise treatment depends much on the medium, the queue structure of the node interface, etc.). For example, virtual conference audio is likely to be classified as ‘telephony’, but for a network service provider, it may be business-critical. New types of flows are also appearing in general usage (IoT, AR/VR and the like). Many of these new flows may be considered imperfectly classified by RFC 4594/2474 etc. In addition, the goal of an efficient QoS mechanism is often not just to apply the correct label, but also to structure an efficient scheduling, at least locally, and possibly end-to-end.

For example, virtual conferencing video can be AF41, but scheduling can cause the device to choose a 360P or a 4K codec (RFC 45934 does not get into these considerations, as is known by those skilled in the art). Thus, embodiments described herein can reuse RFC 4594 in that, once a flow is identified, various methods can apply a DSCP label that conforms with RFC 4594 (but also RFC 2474, in that the local admin can decide of the label). However, one objective in certain embodiments is to also refine the scheduling. Thus, the methods can inform the device of the planned scheduling structure, and forward this scheduling intent to the other (non-Wi-Fi) nodes of the network.

It is contemplated that various embodiments described herein are also different from some implementations of AVC. AVC is traditionally understood to identify the traffic based on some tuples or pattern, then applying RFC 4594's marking. By contrast, certain embodiments herein can listen to the device's request (and in OCE QOS Management, and Wi-Fi 7, the device describes the tuples for the flow, but also its requested general frame pace). The AP may then use AVC or other methods to identify the flow, observe its scheduling capability, and conclude on a scheduling possibility for that flow. The AP can apply that schedule, and also inform the device about the schedule. This last step can cause the device to reconsider elements of the flow (for example, switching from one CODEC to another, to account for higher/slower scheduling rate given by the AP).

In many embodiments, procedures to achieve network QoS boosting for the SCS flow are utilized and are described in more detail below. For example, in various embodiments, the AP can receive SCS requests specifying detailed traffic characteristics of an application flow (identified by TCLAS) in the QoS Characteristics element. The AP may identify the flow based on TCLAS (IP tuple) or FQDN, based on information received in the SCS request or using DPI. In additional embodiments, the AP can perform a flow lookup in the network policy database for the identified flow to retrieve any configured flow related policy e.g. flow priority (business critical etc.) or hard/soft SLA requirements for the flow.

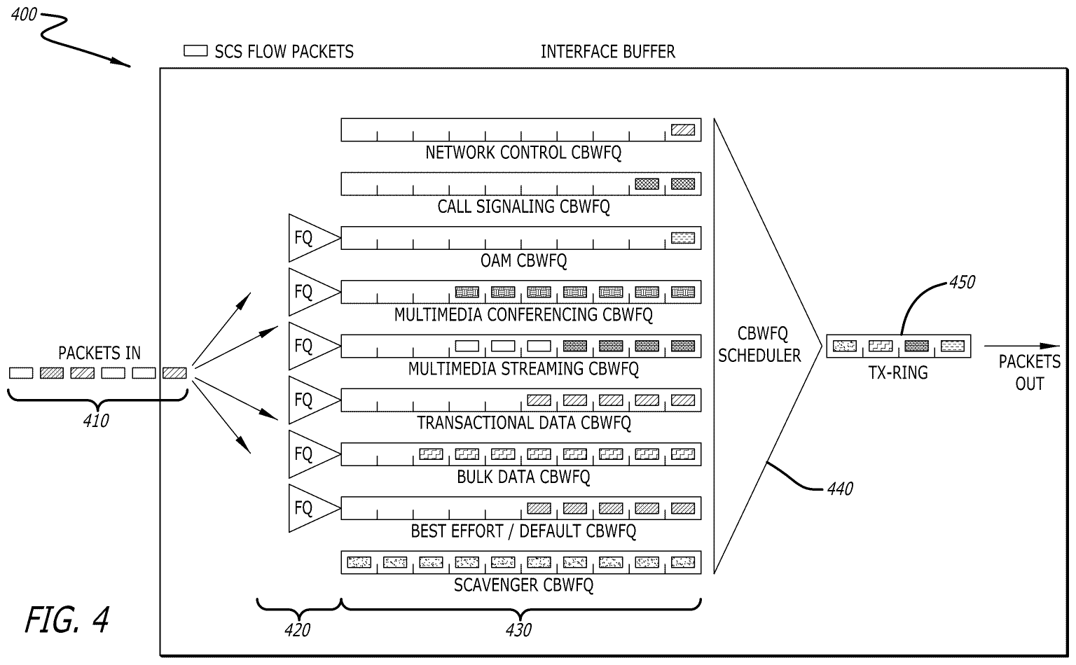

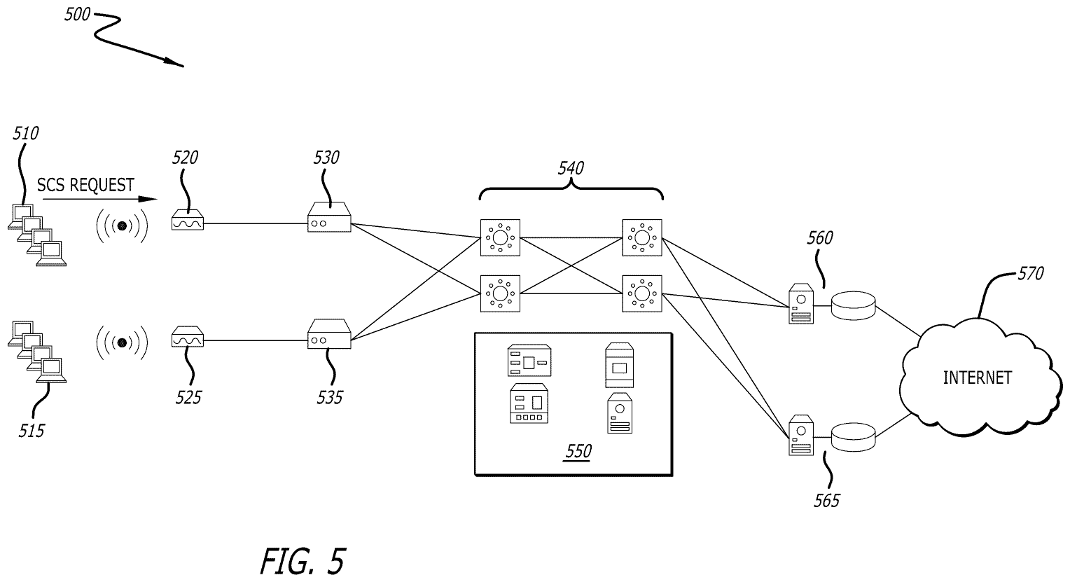

In further embodiments, the AP can consider the traffic characteristics received in the SCS QoS Characteristics element for the flow and configured flow policy, to determine the desired queuing and forwarding behavior/policy for that flow at different network nodes (switches, routers, controllers). This AP behavior may apply to both upstream and downstream flows. In certain embodiments, the AP may then configure each network node with the desired flow level queuing and forwarding logic for the flow (for upstream or downstream), to achieve the per-hop prioritized treatment and QoS boosting for that flow. For example, the AP may map the AR/VR flow which has lower latency requirement to a high priority shallow queue (e.g. the Call Signaling queue) to minimize latency and jitter for that flow as shown in more detail in the embodiment depicted in FIG. 4 below, and configure this flow level mapping information on different network nodes as shown in the embodiment depicted in FIG. 5. In some embodiments, the AP may also inform the device (which originally submitted the SCS request).

Managing data flows and policies often involve intricate considerations, among which scheduling behavior plays a role. Scheduling behaviors can encapsulate the strategies and algorithms employed by network devices, such as routers and switches, to prioritize and process data packets or flows when faced with contention for limited network resources. This aspect of network management is essential for ensuring that different types of traffic receive appropriate treatment in accordance with their Quality of Service (QOS) requirements and service-level agreements.

At the heart of scheduling behavior are various algorithms designed to optimize resource utilization, minimize delays, and meet specific performance objectives. One of the simplest scheduling strategies is First-Come, First-Served (FCFS), where packets are transmitted in the order they arrive at the output queue. While FCFS ensures fairness, it may not be suitable for scenarios where certain types of traffic require priority handling.

To address the need for prioritization, Priority Queuing (PQ) assigns different priority levels to packets or flows based on criteria such as Differentiated Services Code Point (DSCP) markings or packet types. Higher priority packets are transmitted before lower priority ones, ensuring critical traffic receives preferential treatment. However, under heavy load conditions, lower priority traffic may experience delays or even starvation.

Weighted Fair Queuing (WFQ) is another scheduling algorithm that allocates bandwidth to flows based on their assigned weights, typically determined by their QoS requirements. This approach ensures fairness by dynamically adjusting transmission rates to meet the needs of different flows. WFQ is particularly effective in environments with diverse traffic patterns and varying QoS demands.

Class-Based Queuing (CBQ) takes a more granular approach by dividing traffic into different classes or queues based on predefined criteria such as application type, destination, or QoS parameters. Each class may have its own scheduling algorithm, allowing administrators to apply tailored policies to different traffic classes. CBQ provides fine-grained control over resource allocation and prioritization, making it suitable for complex QoS requirements.

Deficit Round Robin (DRR) represents an enhanced version of round-robin scheduling, where each flow is assigned a deficit counter. Flows with data to transmit are served in a round-robin fashion, but if a flow's deficit counter is nonzero, it receives multiple service opportunities until its deficit is cleared. DRR balances fairness with the ability to prioritize low-latency traffic when necessary.

By determining a scheduling behavior, appropriate scheduling algorithms and policies can be configured accordingly, allowing network administrators or management logics to effectively balance fairness, prioritize critical applications, and ensure optimal performance across the network. As those skilled in the art will recognize, additional methods of scheduling behavior may be utilized depending on the application desired. This scheduling behavior can subsequently be forwarded to other network devices associated with a flow that the scheduling behavior is applied to.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

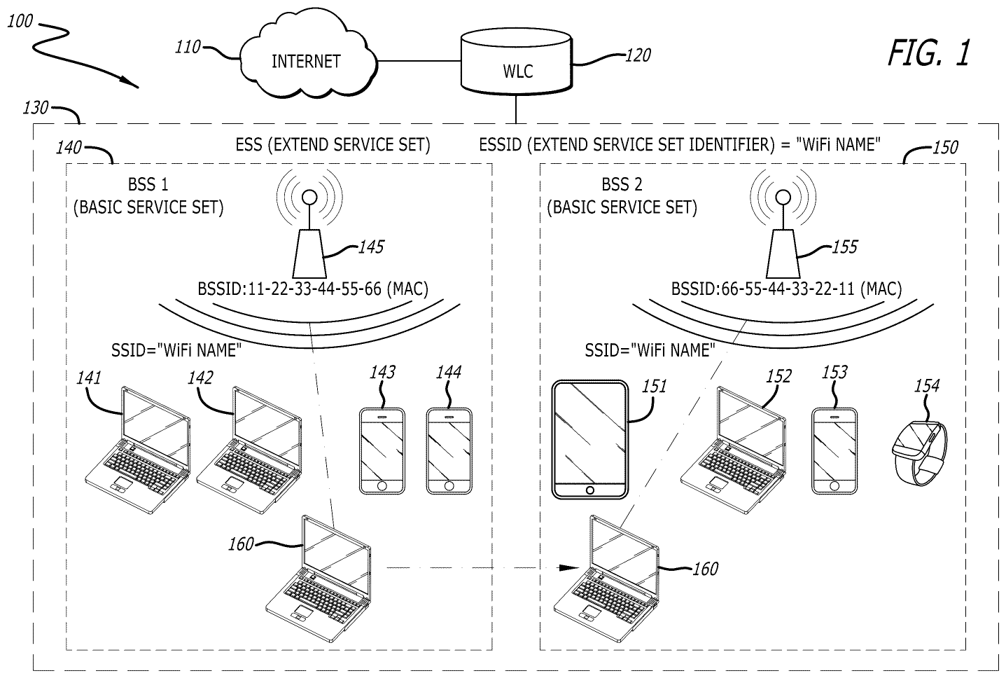

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes-comprising devices like laptops, smartphones, or other Wi-Fi-enabled devices-operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It's crucial to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

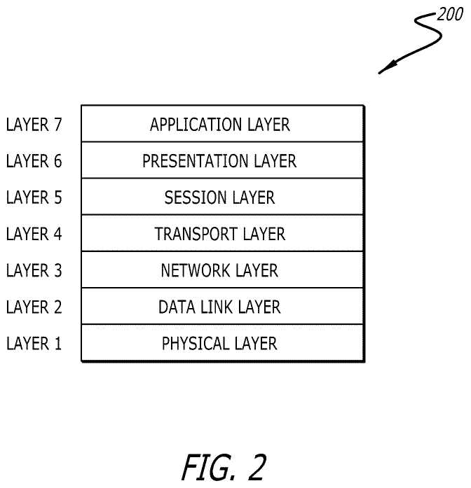

The network can include a variety of user end devices that connect to the network. These devices can sometimes be referred to as stations (i.e., “STAs”). Each device is typically configured with a medium access control (“MAC”) address in accordance with the IEEE 802.11 standard. As described in more detail in FIG. 2, a physical layer can also be configured to communicate over the wireless medium. As described in more detail of FIG. 4, various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140 and BSS 2 150 all broadcast and are configured with the same SSID “Wi-Fi Name”, which can be a BSSID for each of the BSS 1 140 and BSS 2 150 as well as a ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and second BSS 2 150. In this setup, third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer, can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer, can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIGS. 3-6 as required to realize a particularly desired embodiment.

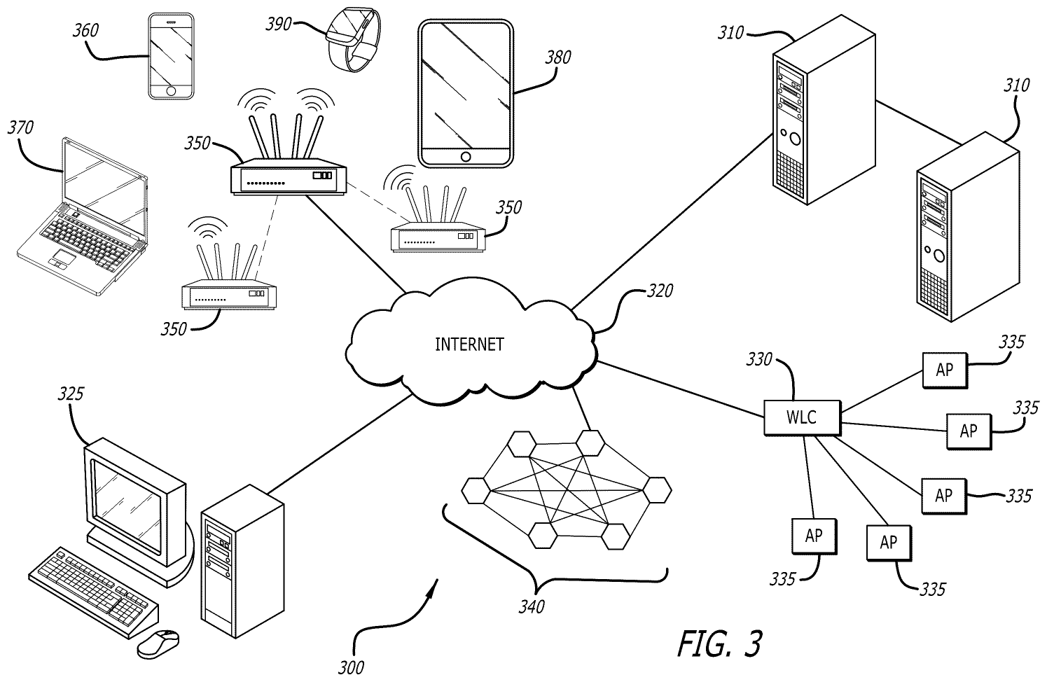

Referring to FIG. 3, a conceptual network diagram 300 of various environments that a flow management logic may operate on a plurality of network devices, in accordance with various embodiments of the disclosure is shown. Those skilled in the art will recognize that the flow management logic can include various hardware and/or software deployments and can be configured in a variety of ways. In many embodiments, the flow management logic can be configured as a standalone device, exist as a logic in another network device, be distributed among various network devices operating in tandem, or remotely operated as part of a cloud-based network management tool. In further embodiments, one or more servers 310 can be configured with the flow management logic or can otherwise operate as the flow management logic. In many embodiments, the flow management logic may operate on one or more servers 310 connected to a communication network 320 (shown as the “Internet”). The communication network 320 can include wired networks or wireless networks. The flow management logic can be provided as a cloud-based service that can service remote networks, such as, but not limited to a deployed network 340.

However, in additional embodiments, the flow management logic may be operated as a distributed logic across multiple network devices. In the embodiment depicted in FIG. 3, a plurality of network access points (APs) 350 can operate as the flow management logic in a distributed manner or may have one specific device operate as the flow management logic for all of the neighboring or sibling APs 350. The APs 350 may facilitate Wi-Fi connections for various electronic devices, such as but not limited to, mobile computing devices including laptop computers 370, cellular phones 360, portable tablet computers 380 and wearable computing devices 390.

In further embodiments, the flow management logic may be integrated within another network device. In the embodiment depicted in FIG. 3, a wireless LAN controller (WLC) 330 may have an integrated flow management logic that the WLC 330 can use to monitor or control power consumption of the APs 335 that the WLC 330 is connected to, either wired or wirelessly. In still more embodiments, a personal computer 325 may be utilized to access and/or manage various aspects of the flow management logic, either remotely or within the network itself. In the embodiment depicted in FIG. 3, the personal computer 325 communicates over the communication network 320 and can access the flow management logic of the servers 310, or the network APs 350, or the WLC 330.

Although a specific embodiment for various environments that the flow management logic may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the flow management logic may be provided as a device or software separate from the WLC 330 or the flow management logic may be integrated into the WLC 330. The elements depicted in FIG. 3 may also be interchangeable with other elements of FIGS. 1-2 and FIGS. 4-10 as required to realize a particularly desired embodiment.

Referring to FIG. 4, a conceptual illustration of a stream classification service queuing/forwarding system, in accordance with various embodiments of the disclosure is shown. Specifically, in the embodiment depicted in FIG. 4, an interface buffer 400. In many embodiments, an interface buffer is a component in managing the flow of data packets or frames, particularly concerning stream classification service requests.

When data packets 410 or frames arrive at a wireless network node, they are initially directed to the interface buffer 400 associated with that node for temporary storage. This interface buffer 400 can serve as a holding area while the network node processes stream classification service requests. These requests, which may come from various applications or services, seek to categorize, or prioritize data streams based on specific criteria like quality of service (QOS), traffic type, or security needs.

During this process, the interface buffer 400 can facilitate the inspection of incoming data, enabling the network node to extract pertinent information for classification and decision-making. Once stream classification service requests are handled, the network node classifies the incoming data packets into various categories or classes based on the specified criteria. The interface buffer 400 may then manage multiple queues to organize the data packets according to their assigned categories or priorities. This queue management can help to improve efficient processing and transmission of data in line with the requested requirements.

In the embodiment depicted in FIG. 4, the interface buffer 400 accepts incoming packets 410 which are then processed into a plurality of fair queues 420 (shown as “FQ”). In wireless networking queues, Fair Queuing (“FQ”) is a queuing discipline used to manage the transmission of data packets within network queues, ensuring that all flows or traffic streams receive fair and equitable access to network resources. The objective of Fair Queuing is to allocate bandwidth fairly among different flows or connections, regardless of their size or transmission rates. This can be achieved by dividing the available bandwidth among active flows or connections in a manner that prevents any single flow from dominating the network and starving other flows of bandwidth.

Fair Queuing works by assigning each flow or packet a virtual start time based on its arrival time and the amount of data it has transmitted previously. When packets are dequeued for transmission, the one with the earliest virtual start time is selected, ensuring that flows progress fairly and evenly. Fair Queuing helps prevent the occurrence of phenomena such as packet starvation, where certain flows receive preferential treatment at the expense of others, leading to unfair bandwidth allocation and degraded performance for some users or applications. By ensuring equitable access to network resources, Fair Queuing helps maintain a balanced and efficient network operation in wireless environments.

In a number of embodiments, such as the one depicted in FIG. 4, these fair queues 420 can be configured such that they are associated with a plurality of class-based weighted fair queues 430. Class-Based Weighted Fair Queuing (“CBWFQ”) is a queuing discipline used to manage the transmission of data packets within network queues, providing a mechanism for prioritizing and controlling traffic based on predefined classes or categories. CBWFQ extends the basic Fair

Queuing (FQ) algorithm by allowing network administrators to define multiple traffic classes and allocate bandwidth to each class according to specific policies or requirements. Each traffic class is assigned a certain amount of bandwidth, and packets belonging to different classes are placed into separate queues.

Within each queue, packets are scheduled for transmission using a weighted fair queuing mechanism, where each class is assigned a weight that determines its relative share of the available bandwidth. This allows network administrators to prioritize certain types of traffic over others, ensuring that critical applications receive the necessary resources and QoS treatment. CBWFQ enables fine-grained control over traffic management and QoS provisioning in wireless networks, allowing administrators to tailor network performance to meet the specific requirements of different applications or users. By classifying traffic into distinct classes and assigning bandwidth quotas to each class, CBWFQ helps optimize resource utilization, minimize congestion, and ensure a consistent level of service for all traffic streams.

In more embodiments, the plurality of class-based weighted fair queues 430 can be managed or otherwise feed into a CBWFQ scheduler 440. In various embodiments, a CBWFQ scheduler can orchestrate the interaction with a plurality of class-based weighted fair queues 430 by dynamically overseeing the transmission of packets according to the priorities and bandwidth allocations assigned to each queue. Initially, incoming packets can be sorted into various queues based on predefined classes, which are typically established by network administrators and may be defined by criteria such as IP addresses, protocols, port numbers, or packet attributes.

Each queue corresponds to a specific class of traffic and is associated with a designated priority level and bandwidth allocation. The scheduler maintains distinct queues for each class and oversees the transmission of packets within these queues based on their assigned parameters. Utilizing a Weighted Fair Queuing (WFQ) algorithm within each queue, the scheduler can ensure that packets are transmitted in a fair manner, with higher priority queues given precedence over lower priority ones. However, fairness is preserved within each queue based on the configured weights. As packets arrive at the scheduler, they are placed into their respective queues based on their classification, and the scheduler services these queues by transmitting packets from higher priority queues first, while also allocating bandwidth to lower priority queues based on their weights. Moreover, the scheduler can dynamically adjust the bandwidth allocation among the queues in response to changing network conditions, enabling efficient utilization of resources and maintaining Quality of Service (QOS) for different types of traffic.

In a CBWFQ system, stream service requests can undergo a structured process to ensure the effective management of various types of network traffic. Initially, network administrators or logics can identify and categorize traffic streams based on specific criteria such as source and destination IP addresses, protocols, application types, or the like. This classification may allow for the creation of distinct classes of traffic, each with its own set of characteristics and requirements.

Once traffic streams are categorized, administrators configure stream service requests to define the quality of service (QOS) parameters for each class of traffic. These parameters include specifications such as minimum and maximum bandwidth allocations, latency thresholds, packet loss tolerances, and priority levels. By configuring these requests, administrators can tailor the network's behavior to meet the specific needs of different types of traffic, ensuring that critical applications receive the necessary resources while still providing fair access to resources for other types of traffic.

With the stream service requests configured, the CBWFQ system can allocate resources to each class of traffic based on the defined QoS parameters. Higher-priority traffic classes, for example, may receive larger bandwidth allocations or are given preferential treatment in the queueing and transmission process. This resource allocation mechanism can ensure that critical applications, such as voice or video communication, are prioritized and provided with sufficient resources to maintain their performance levels, even during periods of high network congestion.

As packets from different traffic classes arrive at the network device, they are placed into separate queues based on their classification. The CBWFQ scheduler manages the transmission of packets within each queue, utilizing a weighted fair queuing algorithm to ensure fair and efficient utilization of available bandwidth. Higher-priority queues are serviced first, followed by lower-priority queues, with each queue receiving a proportionate share of the available bandwidth based on its configured parameters. This queue management approach helps maintain QoS guarantees for critical applications while also allowing for the equitable distribution of network resources among various traffic types.

Finally, the packets scheduled for transmission can be sent to a transmission ring 450 (shown as “Tx-Ring”) prior to being sent over the transmission medium. As those skilled in the art will recognize, the transmission ring 450 is typically the structure used for managing the transmission of packets from the network interface to the network medium. Essentially, a Tx Ring is often a circular buffer or queue where outgoing packets are stored temporarily before being transmitted over the network. In certain embodiments, when a packet is ready to be sent, it is placed into the Tx Ring by the network interface controller.

In various embodiments described herein, the number and characteristics of queues may be modified to better align with the desired QoS levels of the current data being transmitted. In some embodiments, this modification can be indicated by an incoming flow modification message, such as in an internet protocol header. In certain embodiments, the interface buffer 400 may be part of a wired network node connection within the path being traversed by one or more flows.

Although a specific embodiment for a stream classification service queuing/forwarding system suitable for carrying out the various steps, processes, methods, and operations described herein is discussed with respect to FIG. 4, any of a variety of systems and/or processes may be utilized in accordance with embodiments of the disclosure. For example, the specific structure of the interface buffer may vary depending on the specific application desired. The elements depicted in FIG. 4 may also be interchangeable with other elements of FIGS. 1-3 and FIGS. 5-10 as required to realize a particularly desired embodiment.

Referring to FIG. 5, a conceptual illustration of network queueing/forwarding policy modifications being set by an access point 520, in accordance with various embodiments of the disclosure is shown. In many embodiments, an access point 520 can consider the configured flow policy and traffic characteristics received in a stream classification service request provided by a first set of end user devices 510 and/or any associated quality of service characteristic elements related to the flow. These can be utilized to determine if any medication of a flow policy is needed, such as, but not limited to, remarking any differentiated services code point items, such as in a type of service IP header. This can be done both for upstream flows and/or for downstream flows. This modified flow policy can be sent or otherwise forwarded to other network node devices within the network serving the flow to modify the queueing strategy/forwarding treatment accordingly. These modifications can be done on a per-packet basis in certain embodiments.

In certain embodiments, the access point 520 can identify a flow based on an IP tuple. As those skilled in the art will recognize, an IP tuple can be configured as a set of information to uniquely identify a communication flow or session within a network. This information may include, but is not limited to, source IP address, destination IP address, source port number, destination port number, and/or protocol. An IP tuple, such as a Traffic Class (TCLAS) or Fully Qualified Domain Name (FQDN), can serve as a key identifier for network flows within a communication session. These tuples are useful in various networking processes, including flow classification, Quality of Service (QOS) management, and traffic filtering.

When used to identify a flow, an IP tuple typically consists of multiple components that together uniquely characterize a communication stream. For instance, in the case of TCLAS, the tuple might include source and destination IP addresses, source and destination port numbers, protocol type (e.g., TCP or UDP), and possibly additional header fields. Each component provides specific information about the flow, such as its origin, destination, and communication parameters. In the context of flow identification, the IP tuple acts as a fingerprint that distinguishes one flow from another. By examining the tuple's components, network devices can determine whether incoming packets belong to an existing flow or represent a new communication session. This enables efficient flow tracking and management throughout the network. Furthermore, IP tuples play a crucial role in flow classification, where traffic is categorized into different classes or service levels based on predefined criteria. For example, network administrators may define QoS policies that prioritize traffic from specific source-destination pairs or applications identified by their FQDNs. By inspecting the IP tuples of incoming packets, network devices can apply these policies to ensure that critical flows receive the necessary resources and treatment.

In further embodiments, the access point 520 can subsequently communicate the modified flow policy back to the first set of end user devices 510 or any end user devices that initiated the stream classification service request. In some embodiments, the access point 520 can override the suggested stream classification requested. Subsequently, the access point 520 can communicate this back to the requested network device. In various embodiments, upon receiving the modified flow policy, the requesting network device, such as an end user device, can itself change or otherwise modify its stream and/or flow structure.

In the embodiment depicted in FIG. 5, a first set of end user devices 510 is in wireless communication with an access point 520. Likewise, a second set of end user device 515 are also in wireless communication with a second access point 525. The access point 520 is connected to a first network node 530 while the second access point 525 is connected to a second network node 535. Both the first network node 530 and second network node 535 are connected to a set of additional network nodes 540. In some embodiments, a server farm 550 or other network components can be in communication with the set of network nodes 540.

The set of network nodes 540 can be further connected to additional devices. In the embodiment depicted in FIG. 4, the set of network nodes 540 are connected to a first server 560 and a second server 565. Both the first server 560 and second server 565 are themselves connected to the internet 570. However, in some embodiments, the connection may be to an intranet or some other internal network.

Although a specific embodiment for network queueing/forwarding policy modifications being set by an access point suitable for carrying out the various steps, processes, methods, and operations described herein is discussed with respect to FIG. 5, any of a variety of systems and/or processes may be utilized in accordance with embodiments of the disclosure. For example, those skilled in the art will recognize that the specific layout, connection, arrangement, and/or selection of network devices can vary from deployment to deployment based on the needs of the desired application. The elements depicted in FIG. 5 may also be interchangeable with other elements of FIGS. 1-4 and FIGS. 6-10 as required to realize a particularly desired embodiment.

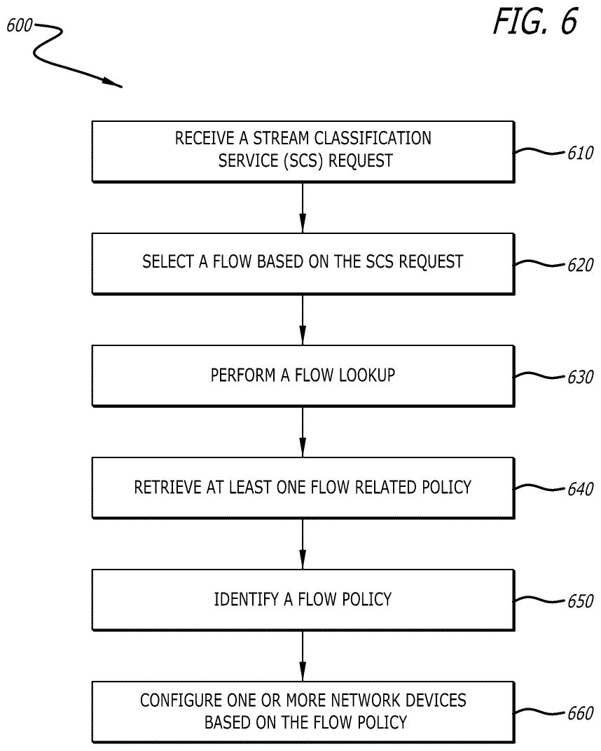

Referring to FIG. 6, a flowchart depicting a process 600 for configuring network devices based on flow policies in accordance with various embodiments of the disclosure is shown. In many embodiments, the process 600 can receive a stream classification service (SCS) request (block 610). In some embodiments, the SCS request is configured to specify detailed characteristics of associated traffic. In more embodiments, the configuration is through a traffic class (TCLAS) quality of service (QOS) element.

In a number of embodiments, the process 600 can select a flow based on the SCS request (block 620). As described above, the stream associated with the SCS request can be classified into one or more classifications. The flow can have a plurality of characteristics that can be aligned with the desires and/or requirements of the stream associated with the SCS request.

In more embodiments, the process 600 can perform a flow lookup (block 630). In certain embodiments, the flow lookup can be within a network policy database. As those skilled in the art will recognize, the location and type of network policies that can assigned to or otherwise associated with a flow can vary from deployment to deployment based on the application desired.

In additional embodiments, the process 600 can retrieve at least one flow related policy (block 640). Often, these flow related policies can include a priority associated with the flow. In some embodiments, the flow related policies can include hard or soft service level agreement requirements for the flow.

In further embodiments, the process 600 can identify a flow policy (block 650). As described above, the network administrator or logic can determine that the typical category that would normally be assigned to the stream may not be optimal and should be modified. In response, various embodiments of the process 600 can determine a different desired queueing and forwarding policy for the flow that may be more appropriate for the stream. In more embodiments, the process 600 can determine if the modified policy should be applied to the upstream and/or downstream traffic. In more embodiments, the process 600 can identify a pre-existing flow policy that would best be applied to the selected flow.

In still more embodiments, the process 600 can configure one or more network devices based on the flow policy (block 660). The flow policy can be a new or modified scheduling behavior that must subsequently be transmitted, forwarded, or otherwise passed along to the other network devices/nodes that are associated with the upstream and/or downstream flows. This communication to other network nodes can be done through various IP header modifications, such as a categorization or a re-categorization of the Differentiated Services Code Point (DSCP) markings. In this way, the DSCP markings can be configured to trigger a modification to the flow policy in other network devices in the upstream and/or downstream flow chain.

Although a specific embodiment for a process 600 for configuring network devices based on flow policies suitable for carrying out the various steps, processes, methods, and operations described herein is discussed with respect to FIG. 6, any of a variety of systems and/or processes may be utilized in accordance with embodiments of the disclosure. For example, the process 600 may, in some embodiments, also inform the requesting stream device about the flow policy or scheduling behavior modification. In this way, the requesting device may choose to alter the stream characteristics. The elements depicted in FIG. 6 may also be interchangeable with other elements of FIGS. 1-5 and FIGS. 7-10 as required to realize a particularly desired embodiment.

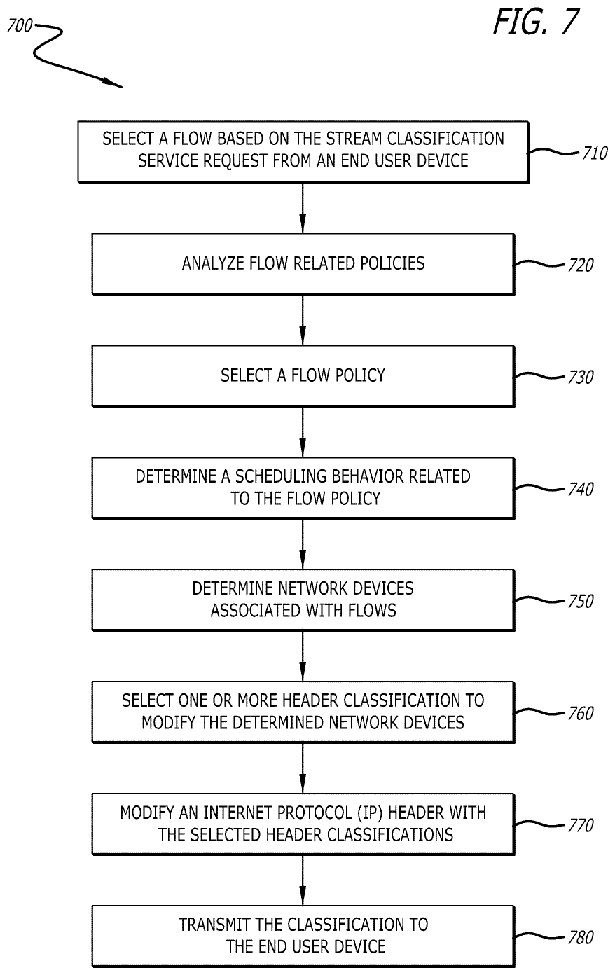

Referring to FIG. 7, a flowchart depicting a process 700 for modifying a flow classification in accordance with various embodiments of the disclosure is shown. In many embodiments, the process 700 can identify a flow based on the stream classification service request from an end user device (block 710). For example, a mobile computing device may initiate a video conference application that generates one or more streams related to audio and/or video communication. The process 700 can receive a stream classification service (SCS) request which can be utilized to determine a flow that is most appropriate for that stream.

In more embodiments, the process 700 can analyze flow related policies (block 720). The flow related policies can be associated with QoE, QoS, and/or SLA requirements. In more embodiments, the policies can relate to other aspects of a flow, such as timing requirements, or category settings for the available flow categories within the network.

In additional embodiments, the process 700 can select a flow policy (block 730). As described above, the network administrator or logic can determine that the typical category that would normally be assigned to the stream may not be optimal and should be modified. In response, various embodiments of the process 700 can generate a different desired queueing and forwarding policy for the flow that may be more appropriate for the stream. In more embodiments, the process 700 can determine if the modified policy should be applied to the upstream and/or downstream traffic. In various embodiments, the process 700 can select a pre-existing flow policy, such as from a plurality of flow policies that are associated with the current characteristics associated with the flow.

In numerous embodiments, the process 700 can determine a scheduling behavior related to the flow policy (block 740). As discussed above, the scheduling behavior can be associated with the strategies and/or algorithms employed by various network devices that will be associated with the flow(s). In some embodiments, the network devices can be nodes, such as, but not limited to, routers, switches, or other devices that process data packets along the flow(s).

In further embodiments, the process 700 can determine network devices associated with flows (block 750). Based on the selection of upstream or downstream classification or reclassification, the network devices or nodes associated with each flow can be determined. The nodes can be within a local network only in certain embodiments. However, in more embodiments, the network devices can be across the entire transmission associated with the modified flows, such as over the internet.

In still more embodiments, the process 700 can select one or more header classifications to modify the determined network devices (block 760). In various embodiments, the packets associated with the flow(s) can comprise IP headers which may be configured to have one or more elements. These elements, or at least some elements, can be associated with classifications of the packet(s). These header classifications can be selected for modification for traffic associated with the modified flow data.

In yet additional embodiments, the process 700 can modify an internet protocol (IP) header with the selected header classifications (block 770). Upon selection, the process 700 can modify the selected header classifications to align with an indication that can be utilized to configure other network devices. As a result, the modification of the header classification can be parsed by other network devices in such a way that changes in how a flow is handled can occur. In this way, the desired modifications can be sent to all network devices associated with the flow.

In various embodiments, the process 700 can transmit the classification to the end user device (block 780). In some embodiments, notifying the end user device may allow for it to evaluate, or even change one or more characteristics related to the flow associated with the modified flow policy. In this way, the end user device may attempt to align the characteristics to the available flow policies.

Although a specific embodiment for a process 700 for modifying a flow classification suitable for carrying out the various steps, processes, methods, and operations described herein is discussed with respect to FIG. 7, any of a variety of systems and/or processes may be utilized in accordance with embodiments of the disclosure. For example, the process 700 can also transmit the modified data packets to the network nodes associated with the flow. The elements depicted in FIG. 7 may also be interchangeable with other elements of FIGS. 1-6 and FIGS. 8-10 as required to realize a particularly desired embodiment.

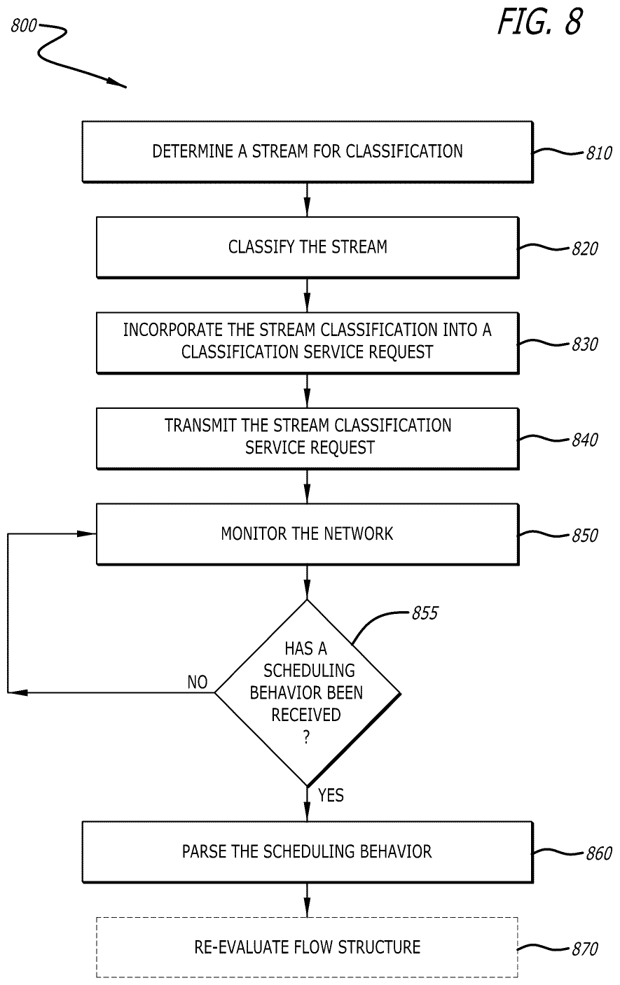

Referring to FIG. 8, a flowchart depicting a process 800 for receiving a modified flow classification in accordance with various embodiments of the disclosure is shown. In many embodiments, the process 800 can determine a stream for classification (block 810). As described above, the process 800 may establish a plurality of streams, often associated with one or more applications associated with the process 800. In some embodiments, the process 800 may be handling or otherwise be directed by another network device to assist in classifying a stream.

In a number of embodiments, the process 800 can classify the stream (block 820). The classification can be associated with the type of data or application that is paired with the stream. In certain embodiments, the process 800 can avoid classifying the stream and send the stream to another network device for classification.

In more embodiments, the process 800 can incorporate the stream classification into a classification service (SCS) request (block 830). As those skilled in the art will recognize, the process 800 can utilize a SCS request to notify other network devices of a stream. The incorporation can be done within an IP header.

In additional embodiments, the process 800 can transmit the stream classification service request (block 840). In some embodiments, the process 800 can transmit the SCS request to an access point that is associated with the process 800. In various embodiments, the transmission can be part of a normal IP header transmission of various data packets.

In further embodiments, the process 800 can monitor the network (block 850). Monitoring the network may include parsing incoming network data. In those embodiments, the parsing can include analyzing incoming data packets and their respective IP headers.

In various embodiments, the process 800 can determine if a modified flow classification has been received (block 855). As described above, the process 800 can receive a modified flow classification and/or policy from another device, such as an access point. In more embodiments, the determination can be done after examining one or more IP headers.

If no modified flow classification has been received, the process 800 can continue to monitor the network (block 850). However, if it is determined that a modified flow classification has been received, then certain embodiments of the process 800 can parse the modified flow classification (block 860). Parsing can be done by examining the IP header. Parsing can also be configured to determine what change has been done to the flow associated with the stream which was part of a SCS request.

In certain optional embodiments, the process 800 can re-evaluate a flow structure (block 870). In some embodiments, the re-evaluation is conducted on a stream associated with the flow structure. The modified flow structure or policy can be different from what was expected. In response, the process 800 may determine that the stream associated with a SCS request and subsequent modified flow classification can be modified to better realize or improve one or more characteristics of the stream.

Although a specific embodiment for a process 800 for receiving a modified flow classification suitable for carrying out the various steps, processes, methods, and operations described herein is discussed with respect to FIG. 8, any of a variety of systems and/or processes may be utilized in accordance with embodiments of the disclosure. For example, the process 800 can transmit the SCS request without parsing or modifying a received flow classification. The elements depicted in FIG. 8 may also be interchangeable with other elements of FIGS. 1-7 and FIGS. 9-10 as required to realize a particularly desired embodiment.

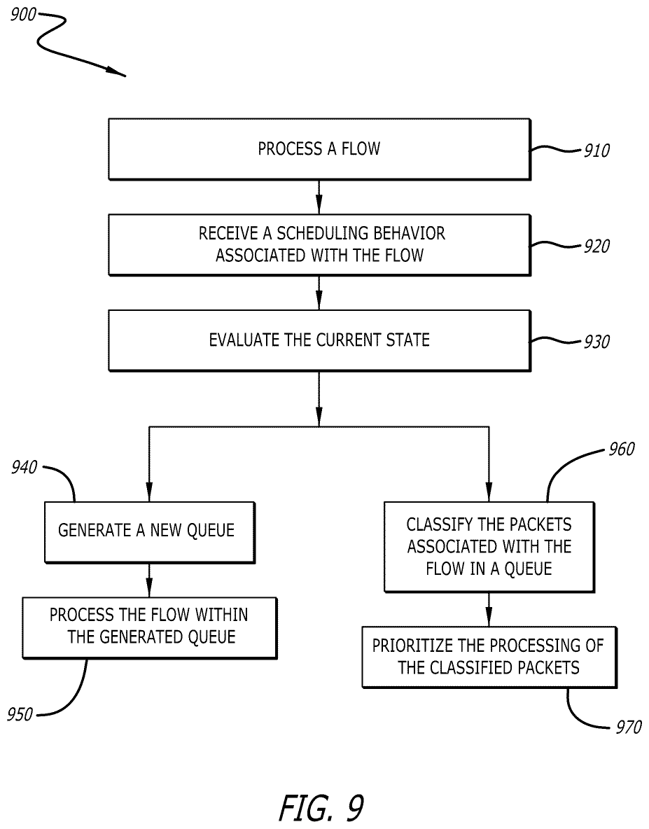

Referring to FIG. 9, a flowchart depicting a process 900 for processing flows is shown. In many embodiments, the process 900 can process a flow (block 910). The flow processing can occur in a manner similar to those described above with FIGS. 1-8. In some embodiments, the process 900 can utilize a queue to process a flow. However, additional queues may be utilized depending on the number of flows currently being processed.

In a number of embodiments, the process 900 can receive a scheduling behavior associated with the flow (block 920). As previously discussed, the scheduling behavior can be formatted to indicate the strategies and/or algorithms that can or should be employed to process a queue. In some embodiments, the process 900 can evaluate the scheduling behavior and determine the best strategy or algorithm to utilize based on the available capabilities.

In more embodiments, the process 900 can evaluate the current state (block 930). The evaluation of the current state can be associated with the number of queues currently utilized, the nature of those queues, the number of flows being processed, the nature of those flows, the available resources, etc. The evaluation can be done in response to the receiving of the scheduling behavior. In certain embodiments, the evaluation is done in response to another event, such as a passage of time, or a change in parameters, etc. In these embodiments, the process 900 can simply utilize the current state to evaluate.

In additional embodiments, the process 900 can generate a new queue (block 940). The current queues that may be present may not match the needs of the scheduling behavior associated with the flow. In response, the process 900 can add or generate a queue that is configured to match the requirements or other characteristics associated with the scheduling behavior.

In further embodiments, the process 900 can process the flow within the generated queue (block 950). The process 900 can subsequently process the flow(s) associated with scheduling behavior. The processing can be done through the one or more newly generated queues.

In certain embodiments, the process 900 can classify the packets associated with the flow in a queue (block 960). In some embodiments, the generation of new queues are determined to not be needed. The processing within the pre-existing queue(s) may be altered in response to the scheduling behavior.

In various embodiments, the process 900 can prioritize the processing of the classified packets (block 970). The flow is processed through a pre-existing queue but is instead marked or otherwise prioritized such that the packets within the queue can be processed in a way that correlates to the scheduling behavior. As those skilled in the art will recognize, there are numerous methods to mark a packet in order to prioritize it or otherwise alter the handling of the packet within the queue.

Although a specific embodiment for a process 900 for processing flows suitable for carrying out the various steps, processes, methods, and operations described herein is discussed with respect to FIG. 9, any of a variety of systems and/or processes may be utilized in accordance with embodiments of the disclosure. For example, the process 900 can both generate new queues and classify packets within a queue to handle the flow processing. Indeed, multiple flows may be associated with a received scheduling behavior, or the device may receive multiple scheduling behaviors. The elements depicted in FIG. 9 may also be interchangeable with other elements of FIGS. 1-8 and FIG. 10 as required to realize a particularly desired embodiment.

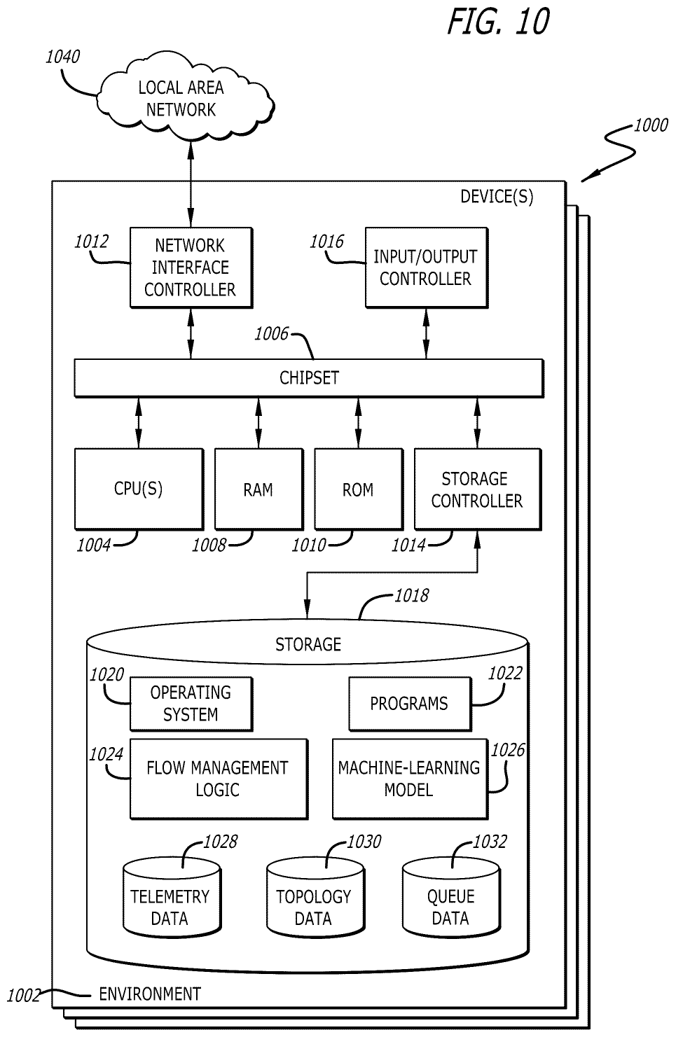

Referring to FIG. 10, a conceptual block diagram of a device suitable for configuration with a flow management logic and a flow management logic, in accordance with various embodiments of the disclosure is shown. The embodiment of the conceptual block diagram depicted in FIG. 10 can illustrate a conventional server, switch, wireless LAN controller, access point, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many non-limiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-8. In certain embodiments, the device 1000 can also include computer-readable storage media having instructions stored thereupon for performing any of the other computer-implemented operations described herein.

In many further embodiments, the device 1000 may include a flow management logic 1024. The flow management logic 1024 can be configured to perform one or more of the various steps, processes, operations, and/or other methods that are described above. Often, the flow management logic 1024 can be a set of instructions stored within a non-volatile memory that, when executed by the controller(s)/processor(s) 1004 can carry out these steps, etc. In some embodiments, the flow management logic 1024 may be a client application that resides on a network-connected device, such as, but not limited to, a server, switch, personal or mobile computing device in a single or distributed arrangement.

In some embodiments, telemetry data 1028 can encompass real-time measurements crucial for monitoring and optimizing network performance. It may include details like bandwidth usage, latency, packet loss, and error rates, providing insights into data transmission quality and identifying potential issues. Telemetry data 1028 may also cover traffic patterns and application performance, supporting capacity planning and ensuring optimal user experience. The collection and analysis of this data are essential for proactive network management, facilitated by advanced monitoring tools and technologies. In more embodiments, the telemetry data 1028 can include packet data as well as the corresponding IP header data.

In various embodiments, topology data 1030 can comprise information detailing the physical or logical arrangement of network devices and their interconnections. This data can provide insights into the structure of the network, including the relationships between routers, switches, servers, and other components. Topology data 1030 can describe the actual layout of devices, such as their placement in a building or across multiple locations, while logical topology data may focus on the communication paths and relationships between devices regardless of their physical location. Understanding network topology is crucial for troubleshooting, optimizing performance, and planning for scalability. It can enable network administrators to identify potential points of failure, ensure efficient data flow, and make informed decisions about network expansion or reconfiguration. Advanced tools and technologies are often employed to visualize and analyze topology data 1030, aiding in the effective management and maintenance of complex network infrastructures.

In a number of embodiments, queue data 1032 may comprise the data stored within the queues for managing and processing network traffic. This queue data can encompass a variety of attributes and parameters that help govern how packets are handled within the system. In some embodiments, the queue data 1032 can include the packet headers, containing vital information such as source and destination IP addresses, port numbers, and protocol types. These headers serve as the foundation for packet classification, flow identification, and routing decisions, allowing a CBWFQ system for example, to differentiate between various types of traffic.

Furthermore, queue data 1032 may include information about weighting and bandwidth allocation for each class of traffic. This data can assist the CBWFQ or other scheduler in determining how to distribute available bandwidth among different traffic classes, ensuring fair and efficient utilization of network resources. By dynamically adjusting weighting and bandwidth allocations based on traffic conditions and QoS policies, the system can adapt to changing network demands and maintain optimal performance.

In more embodiments, queue data 1032 may contain queuing parameters such as queuing delay, packet loss probability, and jitter. These parameters are useful for evaluating the performance of the CBWFQ or similar queueing system and ensuring that QoS objectives are met for different types of traffic. By monitoring and managing queuing parameters, network administrators can fine-tune the queueing configuration to achieve desired performance levels and mitigate potential issues such as congestion and packet loss.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the telemetry data 1028, the power topology data 1030, and the station data 1032. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

ML model(s) 1026 can, in many embodiments, extract relevant features from network traffic data, such as packet size, inter-arrival times, protocol types, port numbers, and statistical properties of the traffic. These features can serve as the basis for characterizing different types of traffic and capturing the underlying patterns and behaviors within the network. ML model(s) 1026 can be used for traffic classification tasks, particularly when labeled datasets are available. These algorithms can learn to recognize patterns and relationships between features and traffic classes by training on labeled traffic data. For example, decision trees, random forests, support vector machines (SVM), and neural networks are popular choices for supervised learning in traffic classification. By leveraging labeled data, these algorithms can accurately classify incoming traffic into predefined categories, such as VoIP, video streaming, or web browsing.

Unsupervised learning techniques are valuable when labeled data is scarce or unavailable. Clustering algorithms, such as k-means clustering or hierarchical clustering, can group similar traffic flows together based on their feature representations. These clusters can then be analyzed to identify different types of traffic or anomalous behavior within the network. Unsupervised learning provides a data-driven approach to traffic classification, allowing network administrators to discover hidden patterns and structures within the traffic data.

Deep learning models, including convolutional neural networks (CNNs) and recurrent neural networks (RNNs), have demonstrated impressive performance in traffic classification tasks. CNNs can automatically learn hierarchical representations of traffic features, while RNNs can capture temporal dependencies in sequential data, such as packet traces or session logs. These deep learning architectures excel at handling complex, high-dimensional traffic data and can adaptively learn from large-scale datasets to improve classification accuracy.

In certain embodiments the ML models(s) 1026 can be combined into multiple ML models 1026 to enhance classification performance. By aggregating predictions from diverse classifiers or feature subsets, ensemble methods can mitigate the limitations of individual models and improve generalization across different traffic scenarios. These can provide a robust and scalable approach to traffic classification, particularly in dynamic network environments where traffic patterns evolve over time.

The use of ML model(s) 1026 are often desired for continuous adaptation and real-time classification in dynamic network environments. These processes can update classification models incrementally as new traffic data arrives, ensuring that the models remain up-to-date and effective in classifying emerging traffic patterns. This can enable adaptive traffic classification solutions that can quickly respond to changes in network conditions and evolving traffic patterns.

Although a specific embodiment for a device suitable for configuration with the flow management logic for carrying out the various steps, processes, methods, and operations described herein is discussed with respect to FIG. 10, any of a variety of systems and/or processes may be utilized in accordance with embodiments of the disclosure. For example, the device 1000 may be in a virtual environment such as a cloud-based network administration suite, or it may be distributed across a variety of network devices or APs. The elements depicted in FIG. 10 may also be interchangeable with other elements of FIGS. 1-8 as required to realize a particularly desired embodiment.

Finally, although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network; and
a memory communicatively coupled to the processor, wherein the memory comprises a flow management logic that is configured to:
receive a stream classification service (SCS) request;
select a flow based on the SCS request;
identify a flow policy;
determine a scheduling behavior related to the flow policy; and
transmit the scheduling behavior to one or more network devices.

2. The device of claim 1, wherein the SCS request is received from a client device.

3. The device of claim 1, wherein determining a scheduling behavior is based on quality of service characteristics of the flow.

4. The device of claim 3, wherein the quality of service is associated with at least one application.

5. The device of claim 1, wherein the flow management logic is further configured to generate a classification based on at least the flow policy.

6. The device of claim 5, wherein the classification is associated with an internet protocol header.

7. The device of claim 6, wherein the classification is a differentiated services code point marking.

8. The device of claim 7, wherein the marking is applied to an upstream flow.

9. The device of claim 1, wherein the flow management logic is further configured to generate one or more queues in response to the scheduling behavior.

10. The device of claim 9, wherein the one or more queues are generated in response to one or more quality of service characteristics of the flow.

11. A device, comprising:
a processor;
at least one network interface controller configured to provide access to a network; and
a memory communicatively coupled to the processor, wherein the memory comprises a flow management logic that is configured to:
determine a flow for classification;
classify the flow;
receive a scheduling behavior for the flow; and
schedule the flow based on the scheduling behavior.

12. The device of claim 11, wherein the flow management logic is further configured to analyze the scheduling behavior.

13. The device of claim 11, wherein the flow management logic is further configured to prioritize the scheduling of the flow based on the analysis of the scheduling behavior.

14. A method of managing flows, comprising:
establishing a connection to a network;
receiving a stream classification service (SCS) request from a network device on the network;
selecting a flow based on the SCS request;
identifying a flow policy based on the SCS request;
determining a scheduling behavior based on the flow policy; and
transmitting the scheduling behavior to the network device.

15. The method of claim 14, wherein the method further includes forwarding the scheduling behavior to additional network devices on a network.

16. The method of claim 15, wherein the additional network devices are not connected via a wireless connection.

17. The method of claim 16, wherein the additional network devices are routing nodes.

18. The method of claim 14, wherein the method further includes generating one or more classifications based on the scheduling behavior.

19. The method of claim 14, wherein the method further includes generating one or more additional queues in response to the scheduling behavior.

20. The method of claim 19, wherein the one or more additional queues are generated based on at least a quality of service characteristic associated with the SCS request.
